(19) United States
(12) Patent Application Publication
(10) Pub. No.: US 2019/0026672 A1
(43) Pub. Date: Jan. 24, 2019

(54) SYSTEM AND COMPUTER PROGRAM FOR IMPLEMENTING AN IMPROVED BLOCKCHAIN FOR USE A VALUE CHAIN

(71) Applicant: Ranjit Notani, Plano, TX (US)

(72) Inventor: Ranjit Notani, Plano, TX (US)

(73) Assignee: One Network Enterprises, Inc., Dallas, TX (US)

(21) Appl. No.: 15/658,131

(22) Filed: Jul. 24, 2017

(51) Int. Cl. G06Q 10/06

(52) U.S. Cl. CPC G06Q 10/06315; H04L 9/0643; G06Q 2220/10

(57) ABSTRACT

A system and computer program product for implementing an improved blockchain for implementing an improved blockchain for use in a value chain network. The system includes a plurality of remote computers in communication with a respective plurality of value chain parties, a service provider computer provided by a service provider over a network, a network interface in communication with the service provider computer and the plurality of remote computers over the network, a backchain initiator residing on the service computer and in communication with the backchain initiator, a content backchain produced by the backchain initiator, and a hold backchain in communication with the plurality of value chain parties. The service provider and the plurality of remote computers are collectively configured to implement a blockchain having one or more shared multi-party transactions represented by one or more blocks in the blockchain. Each of the one or more shared multi-party transactions have A mediated shared state for two or more of the plurality of value chain parties. The backchain initiator is configured to receive all writes to the blockchain. The backchain initiator is provided exclusive unencrypted read access to the mediated shared state and maintains a single version of the truth for each of the mediated shared states. The content backchain is configured to contain the one or more shared multi-party transactions. The hold backchain is configured to receive specialized writes from the plurality of value chain parties.

### BACKGROUND OF THE INVENTION

### Field of the Invention

The present invention is generally related to improved database and network processing, and more particularly to a system and computer program for implementing a blockchain for use in a value chain.

### Discussion of the Background

A blockchain is a technology known in the computer industry that uses a distributed database to maintain a list of records, called blocks, which grow over time. Each block in a blockchain typically contains a timestamp and a link to a previous block. A blockchain is typically managed by a peer-to-peer network which adheres to a protocol to validate new blocks. Functionally, a blockchain serves as a distributed ledger that can record transactions between two parties in a verifiable and permanent way.

A blockchain may be utilized to facilitate secure online transactions. A decentralized digital ledger is used to record transactions across many computers such that a record cannot be altered retroactively without the alteration of all subsequent blocks and the collusion of the network. Blockchains typically use Byzantine fault tolerance to achieve a decentralized consensus among its participants. Validation relies on collective collaboration based on collective self-interest to minimize uncertainty regarding data security to the participants of the blockchain.

One of the first implementations of a blockchain was by Bitcoin as a core component to its digital currency bitcoin, also referred to herein as “cryptocurrency”. When Bitcoin was introduced in 2008, it went on to become the first widely adopted cryptocurrency and an alternative to traditional fiat currencies and commodity currencies. A fiat currency is legal tender whose value is backed by the government that issued it, such as, without limitation, the U.S. dollar and the E.U. euro. A commodity currency is a name given to currencies typically based on raw materials, such, without limitation, as Gold. What distinguishes a bitcoin as a currency is its disintermediating nature in that unlike fiat currencies, it does not require trusted intermediaries (e.g., a bank or a central bank) in order to function. As Bitcoin took off, people began pondering whether the principles of Bitcoin could be applied toward other problems. The specific nomenclature of a “blockchain” was generally derived from a portion of the underlying components of Bitcoin. However, a blockchain is a set of principles that can be interpreted in many different ways and hence there are dozens of types and variations of blockchains.

In the prior art, a blockchain has generally been characterized as a shared database or ledger that anyone can write to and everyone can read, with no central owner. However, this is somewhat misleading because while it is true that anyone can write to the blockchain, the writes to the blockchain are mediated by potentially complex rules and validations that are specific to the blockchain. In the Bitcoin blockchain, for example, one of the rules is that a person cannot spend money they don't have. While a typical database has some rules, referred to as constraints, it typically does not support sophisticated business logic. A blockchain is thus better characterized as a mediated shared database.

The typical characteristics of a traditional blockchain known in the prior art are: (i) a mediated shared state for write purposes; (ii) no central owner of the mediated shared state; (iii) anyone can write to the mediated shared state; (iv) anyone can read the entire shared state without mediation; and (v) there is a delayed single version of the truth.

A database has the connotation of a “thing” that holds the data rather than the data itself. The data itself is often referred to as a state. A blockchain utilizes this concept of a state. The shared state of a blockchain has a probabilistic truthfulness. The likelihood of a transaction being reversed decreases exponentially over time. The lack of a central owner implies that both the shared state (data) and the mediation (i.e., business logic) themselves must be distributed.

### Supply Chains

Supply chains, often called “value chains,” are characterized by a high degree of collaboration, cooperation, and interdependency between the enterprise and other entities or partners in the chain (e.g., raw materials producers, component manufacturers, distributors, and the like). The business goal of managing and optimizing a supply chain is to minimize the costs incurred by all participants in the chain while maintaining a high level of customer service and maximizing profits. In order to achieve this goal, the enterprise strives to reduce the quantity of stored goods in the supply chain, while minimizing opportunity loss by maintaining a sufficient inventory level to satisfy customer demand.

A typical supply chain may span multiple companies and/or entities and sometimes include hundreds or even thousands of companies and/or entities. Each company and/or entity typically maintained its own separate supply chain system. In particular, each company and/or entity maintained its own supply chain network locally on its own computer systems, databases and computer programs associated with the supply chain network. Even with so-called multi-tier or multi-echelon systems known in the prior art, each company and/or entity maintained its own multi-tier or multi-echelon system. The companies would then typically communicate with other companies in the supply chain via exchange messages (typically EDI). These techniques are inherently flawed. According to the prior art, each company had to potentially integrate their own internal supply chain with many if not all of the other companies in the supply chain leading to n² integrations, where ‘n’ is the number of companies in the supply chain. Such an arrangement required additional time and expense in setting up and managing the supply chain, and was highly coupled.

For example, a block diagram illustrating an exemplary simplistic supply chain is shown in FIG. 1D. Each company (seller 112, buyer 114, seller 116, fulfiller 118) in the supply chain 180 would typically maintain its own systems, including separate computer systems (182, 186, 190 and 194) and separate databases (184, 188, 192 and 196). Data related to a particular company (112, 114, 116 and 118) would typically be stored in separate databases (184, 188, 192 and 196). Computer programs operated on these separate computer systems (182, 186, 190 and 194) were required to be maintained by that particular company. The supply chain 180 shown in FIG. 1D is highly coupled. As shown, the internal supply chain of each company (112, 114, 116 and 118) is integrated with the other companies (112, 114, 116 and 118) in the supply chain 180. These integrations are represented by arrowed lines between the computer systems of the companies (112, 114, 116 and 118) over network 124. Because of the business relationship between the companies (112, 114, 116 and 118), a large portion of the data contained within the separate databases (184, 188, 192 and 196) was typically duplicated data over and over again between each of the computer systems of the separate companies (112, 114, 116 and 118) within the supply chain 180. This resulted in an ever-increasing complex web of connections and inter-relationships where there was an attempt to maintain the same data in separate databases (184, 188, 192 and 196) and periodically synchronized that data between the separate databases (184, 188, 192 and 196) and computer systems (182, 186, 190 and 194) within the supply chain 180.

Due to the high degree of coupling in the prior art, any changes in the value chain typically resulted in extensive modifications throughout the supply chain. Due to the size and complexity of most supply chains, schedule-driven and batch processing supply chain management systems of the prior art often resulted in stale or out of date data being used. This led to expensive reconciliation and significantly limited the types of processes that could be executed. It was also difficult if not impossible to deploy new multi-company processes using the techniques known in the prior art. Further, visibility beyond a company's immediate neighbors was problematic because multi-tier visibility was difficult if not impossible to obtain and to orchestrate.

There are several problems associated with a traditional blockchain being used in a supply chain. The biggest problem is that anyone can read the entire shared state without any mediation requirements. This is problematic because not all participants want their information shared with every other participant within the supply chain. For instance, a supply chain participant would not want its information shared with one of its competitors, much less anyone else. As used herein, this problem is referred to as the “everyone-can-read-everything” problem. Supply chains and related business processes are also highly fragmented across thousands of trading partners which typically results in a highly-fragmented state. This leads to higher inventory levels, lower service levels, higher total landed costs and the like.

### Community Blockchains

Over time various attempts have been proposed to solve the problems associated with using a blockchain that would be inherent in its use in a supply chain configuration. However, these attempts have not been able to effectively solve the everyone-can-read-everything problem. Attempts at avoiding the problems in the prior art include a community blockchain, also referred to as a permissioned blockchain or a private blockchain.

In a traditional blockchain, anyone can initiate a mediated write to the shared state and anyone can read the entire shared state. In a community blockchain, however, the parties that can participate in the blockchain is restricted. Only community members allowed by a centralized authority are allowed to read from, or write to, the community blockchain.

The typical characteristics of a community blockchain in the prior art are: (i) a mediated shared state; (ii) a central owner determines who can participate in the community blockchain; (iii) any community member can write to the mediated shared state; (iv) no central owner of the mediated shared state; (v) any community member can read the entire shared state without mediation; and (vi) there is a delayed single version of the truth. Thus, although a community blockchain may solve the everyone-can-read-everything problem in part, it still allows any community member to read the shared state without mediation. This approach is therefore highly problematic which makes it unsuitable to be used for a supply chain. For example, let's assume that the participants of the community blockchain are buyers, vendors, ocean carriers, land carriers, 3PL's, 4PL's, ports, customs, freight forwarders, and the like. One problem is that participants may not want confidential information to be visible to other participants. For instance, a buyer would typically not want another buyer to see information about its orders. Another problem is of course how and who determines the community members. For these reasons and other, a community blockchain is unsuitable to be used in a supply chain configuration.

### Micro-Community Blockchains

A refinement of the community blockchain is the concept of a micro-community blockchain. According to a micro-community blockchain approach, the community blockchain is segregated into a plurality of micro-community blockchains such that the membership of each micro-community is so small that at least in theory the everyone-can-read-everything problem becomes less of an issue.

Possible micro-community blockchain implementations include pairwise micro-community blockchains and per-business-transaction micro-community blockchains. In a pairwise micro-community blockchain, for every pair of trading partners, a pairwise micro-community blockchain is created. Although this is an advance over point-to-point messaging such as electronic data interchange (EDI), the pairwise micro-community blockchain is a massive balkanization of the shared state and the advantages that accrue from that. Further, simple things like a single-version-of-the-truth for multi-party business transactions with more than two parties (workflow arity >2, where arity refers to the number of parties in the workflow: 1(unary), 2(binary), 3(ternary), 4(quarternary), 5(quinary), and the like) would not be feasible with a pairwise micro-community blockchain approach.

In a per-business-transaction micro-community blockchain, for every individual business transaction (e.g., each individual order), a micro-community blockchain is created containing only participants of that particular order. There are major problems associated with this approach. One problem is that it assumes that all of the mediated writes have the same scope as a single business transaction, which is rare if at all. Mediated writes to a business transaction, for example, often require access to master data information as well as information on related transactions which could easily be between parties outside the micro-community blockchain, but are nonetheless associated with the individual business transaction. Another problem is that the data of different micro-communities is inconsistent with respect to each other. Said another way, there is no single version of the truth. There doesn't even exist a delayed single version of the truth that would exist for a single blockchain. Yet another problem is that even on a per-transaction level, the everyone-can-see-everything problem is still an issue in many cases. Yet a further problem is that there are issues associated with cross-micro-community permissions.

FIGS. 1A-1C are block diagrams illustrating an exemplary drop ship scenario in a supply chain known in the prior art. As indicated by identifiers 20 and 30 in FIGS. 1B and 1C, let's assume a buyer places an order with a seller. That seller then shares the order with fulfiller₁ who in turn creates a shipment and tenders it to a carrier for pickup and delivery. Let's further assume that order₁ is associated with one micro-community blockchain and shipment₁ is associated with another micro-community blockchain. Given these assumptions, several major problems exist. One problem is that the micro-community blockchain associated with order₁ is overly inclusive. Here, only the buyer and seller should be allowed to see the price of order₁ and fulfiller₁ has no reason to see the price. But this cannot be achieved with a single micro-community blockchain associated with order₁. One option may be to split the order into two similar order replicas in which one replica includes the price and the other does not include the price. However, this option introduces additional synchronization problems.

Synchronization and consistency problems between different micro-communities also exist. The system of record for the SHIPPED and RECEIVED states is associated with shipment₁. Order₁ must reflect these states. However, at best, there is a delay between the shipment₁ state being propagated to order₁. There is also an issue associated with which party is responsible for this synchronization. Importantly, there is no guarantee that there is always a party who has sufficient permissions to perform the synchronization. As indicated by identifier 10 in FIG. 1A, let's assume shipment₁ is SHIPPED, but this new state has not yet been synchronized with order₁ (which is still in the OPEN state) and the buyer CANCELs order₁. This results in an inconsistent state, and the lack of strong consistency across micro-communities can cause similar and massive inconsistencies.

Yet a further problem is that the buyer, seller and fulfiller₁ need item level details on shipment₁. The carrier must have an aggregated commodity-code based view of shipment₁. However, because the information is replicated to all parties on the transaction, it is not possible to achieve this. Even putting order₁ and shipment₁ into a single, larger micro-community is problematic. Let's assume that order₁ includes two line items, in which one of the line items is fulfilled by fulfiller₁ and the second line item is fulfilled by fulfiller₂ (not shown). Let's further assume that fulfiller₂ tenders to a different carrier (not shown) and that there is a shipment₂ (not shown). Under this scenario, shipment₂ would be required to be put into the same micro-community. However, the parties that should be allowed to see shipment₁ are different than the parties that should be allowed to see shipment₂.

In general, one fundamental issue that must be considered with respect to supply chains is that supply chain multi-party transactions are not compartmentalized. Rather, these transactions form a graph-like structure which sometimes have overlapping or complex boundaries within the graph. This problem cannot be solved by increasing the size of the micro-community because it also increases the everyone-can-see-everything problem.

Thus, there currently exist deficiencies associated with blockchains, and, in particular, with an improved blockchain for use in a value chain network.

### SUMMARY OF THE INVENTION

Accordingly, one aspect of the present invention is to provide a system and computer program product for implementing an improved blockchain for use in a value chain network. The system includes a plurality of remote computers in communication with a respective plurality of value chain parties, a service provider computer provided by a service provider over a network, a network interface in communication with the service provider computer and the plurality of remote computers over the network, a backchain initiator residing on the service computer and in communication with the backchain initiator, a content backchain produced by the backchain initiator, and a hold backchain in communication with the plurality of value chain parties. The service provider and the plurality of remote computers are collectively configured to implement a blockchain having one or more shared multi-party transactions represented by one or more blocks in the blockchain. Each of the one or more shared multi-party transactions have a mediated shared state for two or more of the plurality of value chain parties. The backchain initiator is configured to receive all writes to the blockchain. The backchain initiator is provided exclusive unencrypted read access to the mediated shared state and maintains a single version of the truth for each of the mediated shared states. The content backchain is configured to contain the one or more shared multi-party transactions. The hold backchain is configured to receive specialized writes from the plurality of value chain parties.

Another aspect of the present invention is a system for implementing an improved blockchain for use in a value chain network. The system includes a plurality of remote computers in communication with a respective plurality of value chain parties, a service provider computer provided by a service provider over a network, a network interface in communication with the service provider computer and the plurality of remote computers over the network, one or more frontchains in communication with the plurality of value chain parties, a backchain initiator residing on the service computer and in communication with the backchain initiator, and a content backchain produced by the backchain initiator. The service provider and the plurality of remote computers are collectively configured to implement a blockchain having one or more shared multi-party transactions represented by one or more blocks in the blockchain. Each of the one or more shared multi-party transactions have a mediated shared state for two or more of the plurality of value chain parties. The one or more frontchains are configured to receive all writes from the plurality of value chain parties when everyone-can-see-everything is acceptable for the one or more shared multi-party transactions. The backchain initiator is configured to receive all writes other than those writes which go directly to the one or more frontchains. The backchain initiator is provided exclusive unencrypted read access to the mediated shared state and maintains a transient single version of the truth for each of the mediated shared states. The content backchain is configured to contain the one or more shared multi-party transactions.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIGS. 1A-1C are block diagrams illustrating an exemplary drop ship scenario in a supply chain known in the prior art;

FIG. 1D is a block diagram illustrating an exemplary simplistic supply chain known in the prior art;

FIG. 2A is a block diagram illustrating a simplified exemplary view of different agents orthogonally dividing up a shared state;

FIG. 2B is a timeline illustrating the notion of a single version of the truth (SVOT) over time in accordance with an embodiment of the present invention;

FIG. 2C is a block diagram illustrating various components of a backchain pattern utilized in accordance with a first embodiment of the present invention;

FIG. 2D is a block diagram illustrating the interaction of a trading partner with a frontchain and the backchain system in accordance with a second embodiment of the present invention;

FIG. 2E is a block diagram illustrating the internal structure of backchain initiator in accordance with an embodiment of the present invention;

FIG. 2F is a block diagram illustrating an exemplary ecosystem utilizing the backchain pattern in accordance with an embodiment of the present invention;

FIG. 2G is a block diagram illustrating an exemplary value chain in accordance with an embodiment of the present invention;

FIG. 2H is a block diagram illustrating an exemplary computing environment in accordance with an embodiment of the present invention;

FIG. 2I is a block diagram illustrating an exemplary view of a temporal subnet;

FIG. 2J is a block diagram illustrating blocks growing over time in a simple exemplary blackchain;

FIG. 2K is a block diagram illustrating exemplary blockchains (frontchains and/or backchains) in a peer-to-peer relationship in accordance with an embodiment of the present invention;

FIG. 2L is a block diagram illustrating exemplary use of a backchain initiator in accordance with an embodiment of the present invention; and

FIG. 3A-3D are flow charts illustrating a method for implementing a blockchain in accordance with an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

Because supply chains and related business processes commonly are highly fragmented across thousands of trading partners, they typically result in a highly-fragmented state. Business processes can be dramatically improved by moving from a highly-fragmented state to a mediated shared state. Using the present invention, a supply chain can use a single version of the truth which in turn allows near-real-time sense-and-respond, resulting in dramatically improved business metrics like lower inventory levels, higher service levels, lower total landed costs and the like. It also significantly reduces the computer processing and computer resources required to operate the supply chain, including without limitation reducing the volume of network traffic of the network, over techniques known in the prior art.

The present invention uses several terms defined in Table 1 below.

TABLE 1

| Term | Description |
|---|---|
| command | The command message issued by the end user which is passed to the |
| | backchain initiator. If the write command is in the form of an API call it |
| | may be converted to a command message. It may be expressed in, |
| | without limitation, JSON, XML and the like. A command is typically |
| | applied to one or more objects referred to herein as “business |
| | transactions”. |
| statement | A statement message that is applied to a transactional data store. It is |
| | generally different than a command, which is is typically transformed |
| | before an actual write. For example, a statement may be in the form of a |
| | SQL INSERT, UPDATE, or DELETE. |
| business transaction | An object such as an order or a shipment that is persisted in the data |
| | store. This is different than the ACID transaction of the data store. |
| | Business transactions are typically related to each other via foreign keys |
| | or relationships. The business transaction in this context is typically a |
| | multi-party business transaction. |
| transaction | A set of reads and writes to the data store that are executed with ACID |
| | properties. This is different than a business transaction. Every |
| | transaction has a unique Transaction ID. |
| data store log | The log of the transactional data store. This is automatically produced by |
| | the data store. Every successful transaction results in an entry in the data |
| | store log called an event message. |
| event message | An entry in the data store log. This consists of the results of a successful |
| | transaction. Whereas a command takes the form of “do this”, an event |
| | message is of the form of “this happened”. An event message will |
| | typically capture the state of one or more business transactions when the |
| | transaction is committed. |
| enhanced log | A log that accepts event messages from the data store log and enhances |
| | them to produce an enhanced event message. |
| enhanced event | A message that contains the event message as well as the related |
| message | command that resulted in the event message. The write workflow can be |
| | considered to have two parts. The first part starts with a command and |
| | ends with a transaction being committed to the data store. The second |
| | part starts with reading of an event message from the data store log. |
| backchain event | The message that will be hashed prior to writing to the backchain |
| message (pre-hash) | |
| backchain event | The actual partially cryptographically hashed message that is placed on |
| message | the backchain. |

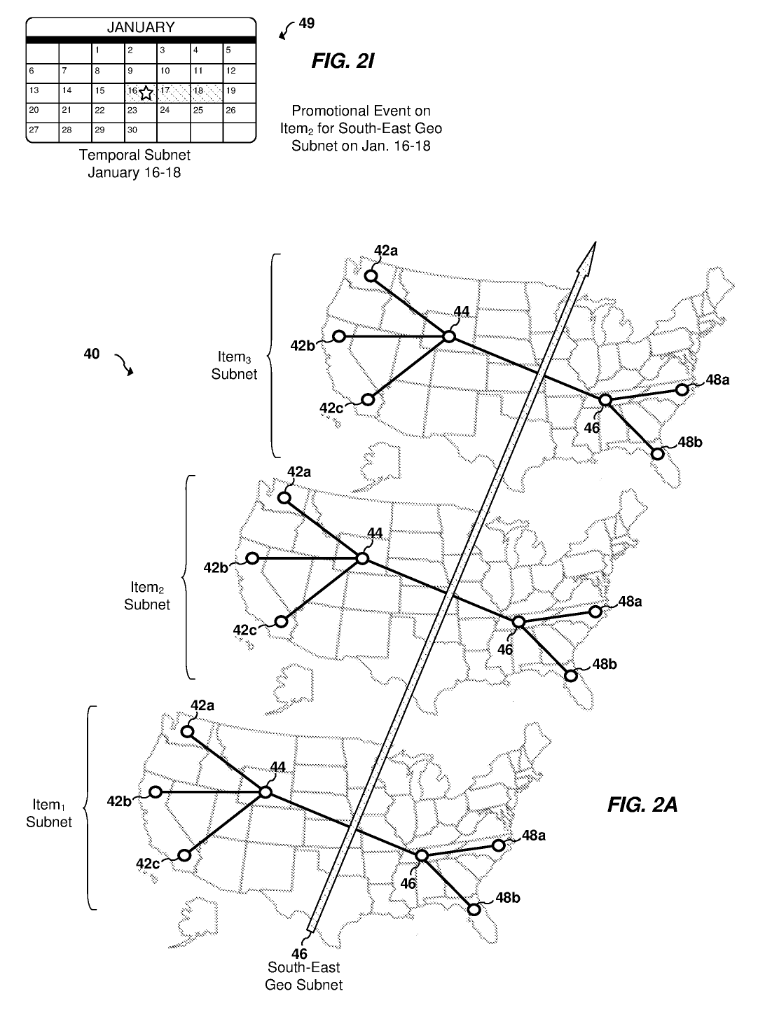

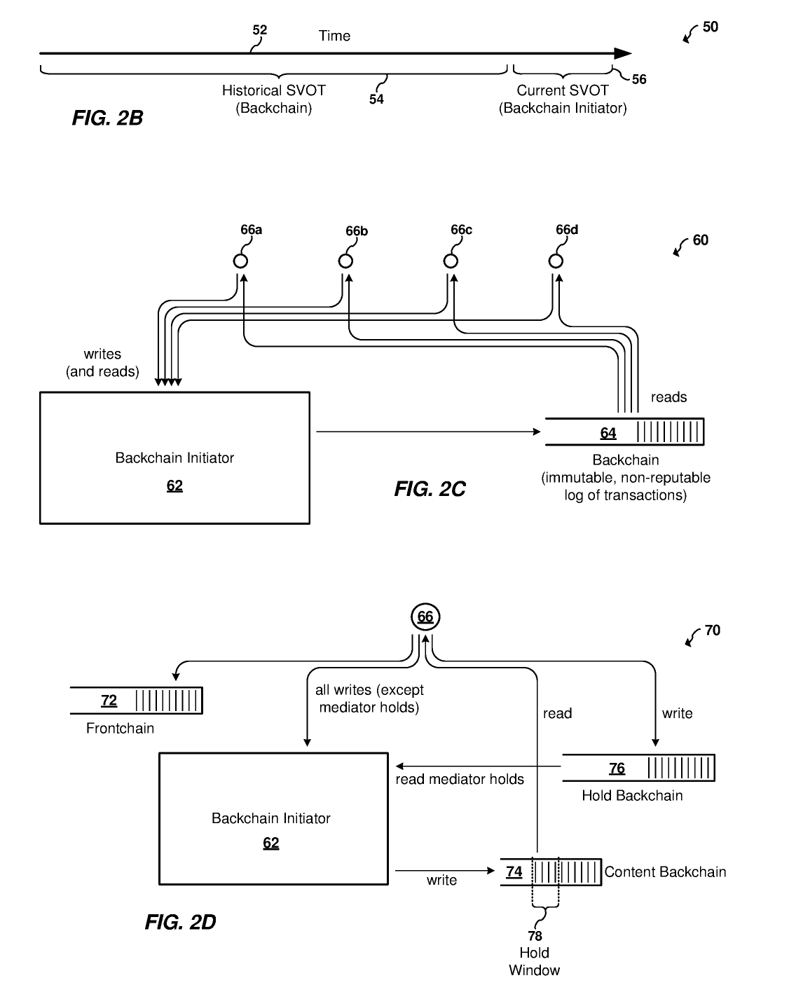

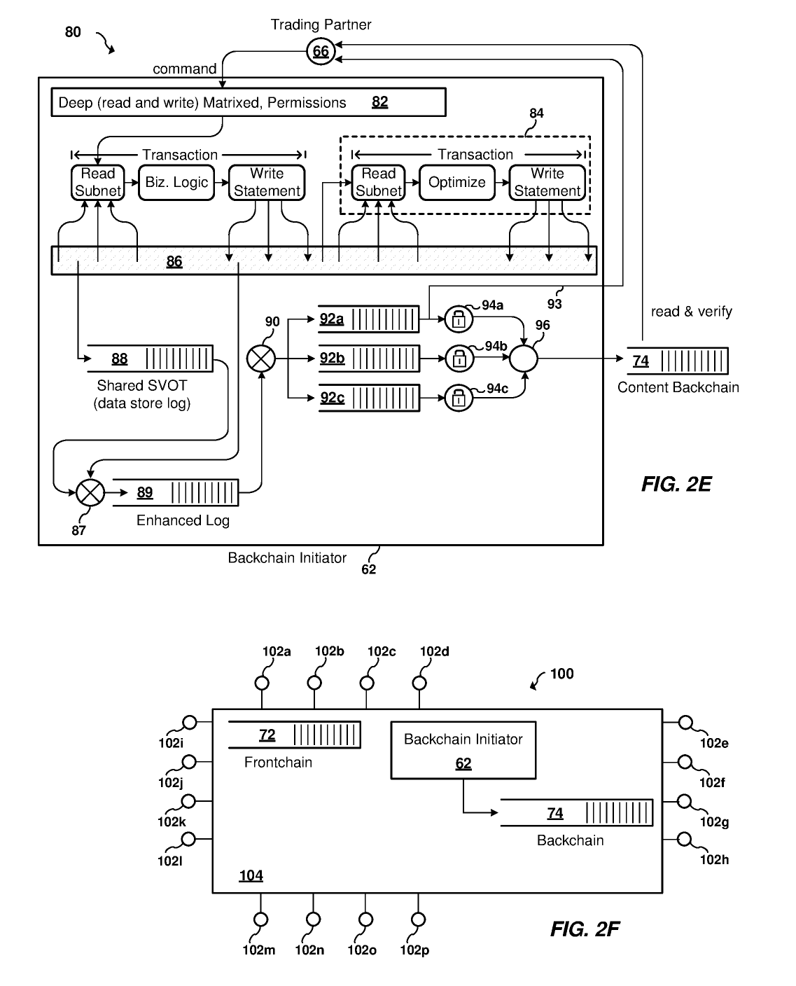

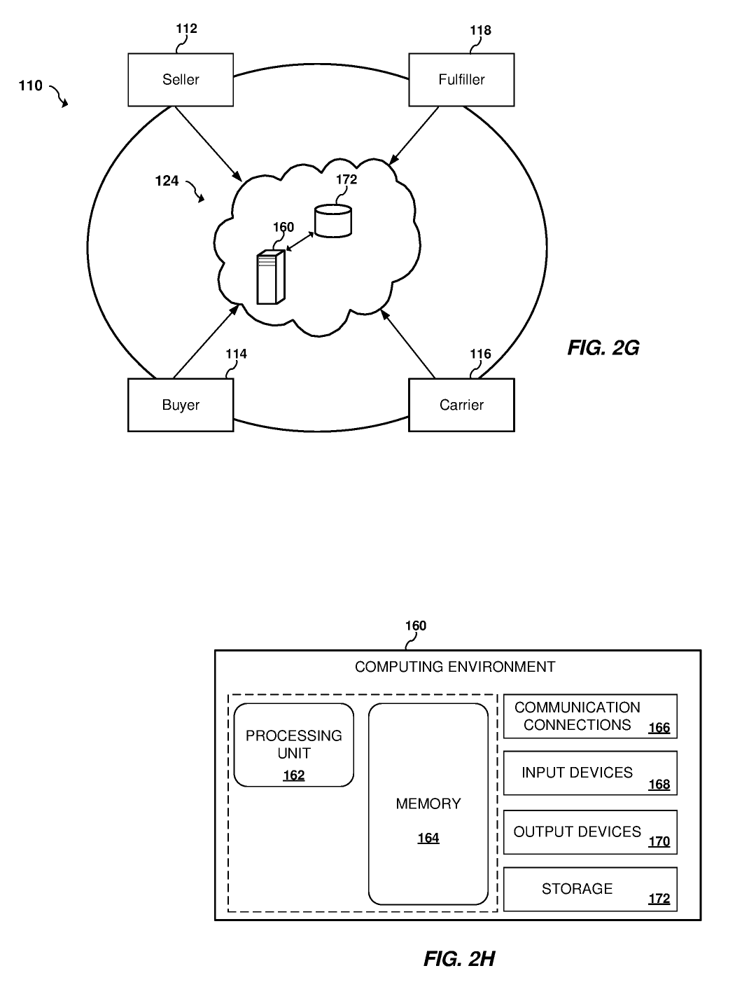

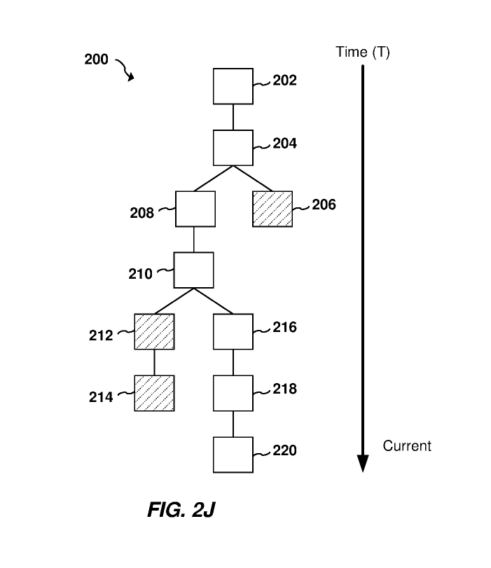

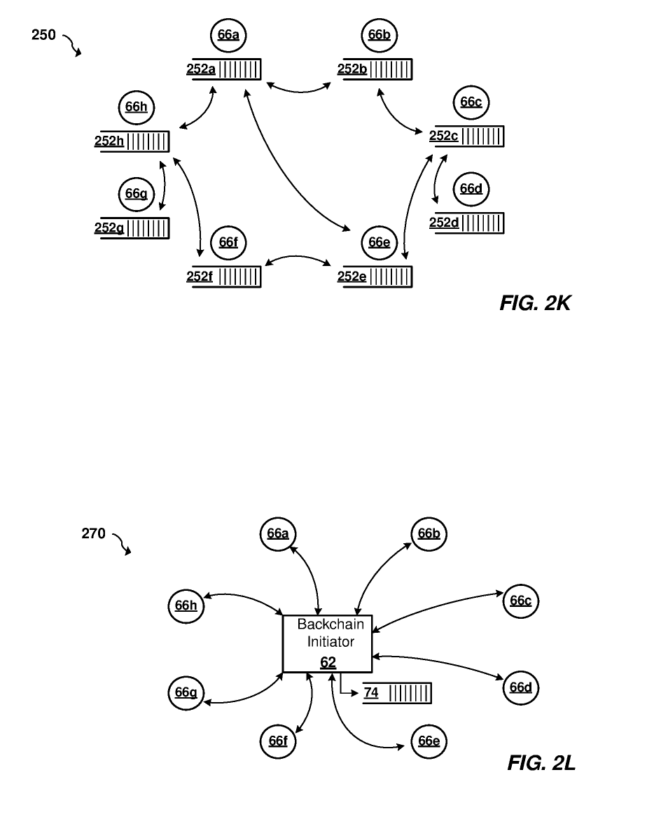

Referring to FIG. 2J, a block diagram illustrating blocks growing over time in a simple exemplary blackchain, is shown. Blocks in the main chain 202, 204, 208, 210, 216, 218 and 220 are the longest series of blocks that go from the beginning block 202 to the current block 220. Blocks 206, 212 and 214 are blocks that are not in the longest chain. Whenever a fork occurs, the block that is received first in time is built upon. Therefore, the short chain of blocks 206, 212 and 214 are not used. A blockchain 100 implementation consists of two types of records: transactions and blocks. Transactions are the actual data stored in the blockchain. According to one embodiment, the data in each block in the blockchain is encrypted. Transactions are created by the present invention to represent multi-party transactions in a value chain network.

### Intelligent Agents

In today's real-time intelligent supply chains, external writes by a party are not the only kind of writes. Intelligent agents constantly monitor the real-time shared state and are triggered by certain events. These intelligent agents read at least a portion of the shared state (often called a subnet), determine how to react to these events (typically using optimization algorithms, linear programming, integer programming, heuristic optimization, stochastic algorithms, machine learning algorithms and the like) and then write back to the shared state. Each intelligent agent works typically over a different (often orthogonal) subnet. Examples of intelligent agents include continuous forecasting, last minute allocation, prioritized expedite, supply disruption, re-promising and the like.

Intelligent agents are at the heart of the revolutionizing potential of mediated shared state and are essentially impossible with techniques known in the prior art, including without limitation the micro-community blockchain approach. Referring to FIG. 2A, a block diagram illustrating a simplified exemplary view 40 of different agents orthogonally dividing up a shared state, is shown. An intelligent agent may need to read from a shared state, react to events, and/or write to a shared state for individual and/or multiple subnets (e.g., item₁ subnet, item₂ subnet, item₃ subnet and the south-east geographical subnet). The intelligent agents may also need to be associated with a temporal subnet such as the exemplary view 49 of a temporal subnet shown in FIG. 2I. In the example shown in FIGS. 2A and 2I, an intelligent agent handles a promotional event on item₂ for the south-east geographical subnet occurring on January 16-19 as defined by a temporal subnet. In this regard, the intelligent agent interacts with the shared state of multiple subnets. As detailed below, a deep, matrixed permissions model is required to handle such an arrangement rather than a shallow, compartmentalized permissions model of micro-community permissioned blockchains, because the interactions are complex and may span multiple subnets. Elements 42, 44, 46 and 48 represent locations or sites.

### Backchains and Backchain Initiators

The present invention sacrifices some decentralization in exchange for other substantial benefits, such as eliminating the everyone-can-see-everything problem. As shown in Table 2, the backchain initiator may be physically distributed, but its ownership is centralized. It may, without limitation, be built on Google cloud spanner which is an ACID database that is physically distributed. However, the backchain initiator would still be operated by the computer systems of a single entity or company. The backchain on the other hand is a blockchain that is both physically distributed and does not have a single owner.

TABLE 2

| Element | Location | Ownership |
|---|---|---|
| Backchain | May be either physically | The computer systems of a single |
| initiator | centralized or distributed, | entity maintain the backchain |
| | | initiator. |
| Backchain | Physically distributed | No single ownership. |

According to the present invention, writes are mediated by backchain initiator 62, which is a centralized entity as defined by Table 2 above. According to an embodiment of the present invention, all writes (other than those to frontchain(s)) are routed through backchain initiator 62. The backchain initiator 62 is provided exclusive unencrypted read access to the entire mediated shared state and maintains a transient single version of the truth of the shared state. This allows the backchain initiator 62 to execute arbitrarity complex mediated writes which may access the full shared state. The backchain initiator 62 can also execute intelligent agents and retrieve the shared state of any required subnet due to its unfettered read access to the entire mediated shared state. Unlike the micro-community blockchain or other approaches known in the prior art, the backchain initiator 62 maintains a single version of the truth. Further, use of a mediated shared state dramatically improves supply chain metrics and database performance.

Once a transaction is mediated by the backchain initiator 62, it is sliced by computer(s) associated with a trading partner (66 and/or 66a-66d), and then hashed (or encrypted) and placed onto content backchain 64, which is a blockchain, by the backchain initiator 62. Such an arrangement provides support for an immutable, non-reputable record of all transactions.

This arrangement also only requires transient trust in the backchain initiator 62 rather than perpetual trust, thus mitigating a key concern of using a centralized trusted entity. Referring to FIG. 2B, a timeline illustrating the notion of a single version of the truth (SVOT) over time, and FIG. 2C, a block diagram illustrating various components of a backchain pattern, are shown. As indicated in FIG. 2B, over time there exists a historical single version of the truth in backchain 64, and a current single version of the truth in backchain initiator 62. The information on the backchain 64 may be encrypted or cryptographically hashed, and therefore the backchain 64 may be, without limitation, a public or community blockchain 64.

The backchain initiator 62 places transactions onto backchain 64, which is a decentralized blockchain. Using this arrangement, the need for trust on a centralized entity is reduced from a perpetual trust to a transient trust. This means that if the backchain initiator 62 is for some reason compromised at some future point in time or is no longer available (e.g., the company hosting the backchain initiator 62 goes out of business), it has no impact on the validity of historical transactions and their non-reputability. This is a massive reduction in reliance on a centralized entity. According to the embodiment shown in FIG. 2C, element 64 represents a content backchain 64. A hold backchain (element 74 in FIGS. 2D and 2E) is not utilized. Because of the lack of a hold backchain, as explained below, there is no way of overcoming the transient trust placed in backchain initiator 62 in the embodiment shown in FIG. 2C.

### Hold Backchain

There is the possibility of a compromised initiator when the backchain is initiated by a centralized entity. One of the major purposes of blockchain is to remove the possibility of compromised intermediaries. The basic issue is a write validation. The way write validation is normally done by centralized shared state mediators is to make callbacks to the impacted parties to validate the final state of the transaction before it is committed to the shared state. However, when dealing with a compromised mediator, this doesn't work because the mediator (the backchain initiator 62 in this case) could just ignore the results of the validation callback that was sent to the impacted partner (66 and/or 66a-66d). The present invention utilizes a hold backchain as described below to solve this problem.

Referring to FIG. 2D, a block diagram illustrating the interaction of a trading partner 66 with a frontchain 72 and the backchain system (62, 74 and 76). Supply Chain or multi-party applications with everyone-can-read-everything or every-member-can-read-everything issues will run on the frontchain(s) 72. The remaining supply chain or multi-party applications will run on the backchain system (62, 74 and 76). A trading partner 66 may interact with frontchain(s) 72 for various reasons. Two or more trading partners (66 and/or 66a-66d) might have an a priori agreement between themselves that specify that when certain types of mediator holds are placed they will automatically move to a frontchain 72. A trading partner 66 might explicitly signal another partner 66 indicating that they would like to move to frontchains for their interactions. If trust is lost with the backchain initiator 62, then the trading partners (66 and/or 66a-66d) might move to a frontchain 72. Frontchain(s) 72 can also be used as a fallback from the backchain system. In this case, the backchain initiator 62 would not be required, but it will be “reduced capabilities” relative to the backchain system. In each of the above, the duration of the interation with the frontchain(s) may or may not be indefinite. For instance, if the trust is re-established with the backchain initiator 62, then they may move back to using the backchain initiator 62. In any case, the backchain 74 itself is still available even if the frontchain 72 is being utilized rather than the backchain initiator 62.

Referring to FIG. 2K, a block diagram 250 illustrating exemplary blockchains 252a-252h, which may be either frontchains 72 and/or a backchains 74 in a peer-to-peer relationship in accordance with an embodiment of the present invention, is shown. Such an arrangement may occur if any of the trading partners 66a-66h are interacting with frontchain(s) 72 rather the blackchain initiator 62 for any of the reasons previous identified. Conversely, FIG. 2L shows a block diagram illustrating exemplary use of a backchain initiator 62 in accordance with an embodiment of the present invention. According to this figure, the backchain 74 itself may be distributed similar to blockchains 252-252h.

However, because frontchains are public-read or public-write, the backchain initiator (like anyone else) can also read or write to a frontchain. The reverse is not true however. Note that according to this embodiment, the backchain is now separated into a content backchain 74 and a hold backchain 76.

In a supply chain, most business transactions, such as orders, shipments, movements, invoices and the like, include the concept of a hold. A hold is a “stop”, “hold” or “limit” of the business transaction in some way. Various types of holds exist including, without limitation, credit holds, inventory holds, invoice dispute holds, and the like. A hold is typically considered a part of the business process that is associated with a business transaction. A hold is often associated with business transactions and is typically asynchronous relative to the business transaction that is being held.

The present invention introduces a new category of holds referred to herein as a “mediator hold”. Normal holds such as credit holds are referred to herein as “normal holds”. Normal holds are applied to business transactions based on the activities of trading partners (66 and/or 66a-66d) (including themselves). Normal holds essentially treat the mediator as transparent or absent. In contrast, a mediator hold is a hold in which there has been a loss of trust or there is an issue with the backchain initiator 62 (the mediator) itself. Mediator holds are written directly to a hold backchain 76, which is another blockchain to ensure that the backchain initiator 62 cannot tamper with mediator holds. Normal holds go to the backchain initiator 62 like all other non-meditator writes.

Frontchain writes will be directed by a trading partner 66 to the frontchain 72 blockchain. The frontchain 72 blockchain may be a public blockchain, a community blockchain, a pair-wise micro-community blockchain, a per-business-transaction micro-community blockchain, another type of micro-community blockchain or any combination thereof.

All writes other than mediator hold writes will be directed to the backchain initiator 62. Once transactions are committed by the backchain initiator 62, they are sliced and intersected and then cryptographically hashed or encrypted and placed onto the content backchain 74. The transaction slices and intersections are also sent by the backchain initiator 62 to the trading partner. The trading partner has a finite amount of time, which is defined by the hold window 78, during which time it may confirm the transactions sent to it and the transaction placed onto the content backchain 76.

A confirmation is performed by cryptographically hashing the slices and intersections passed to the trading partner 66 and then comparing it with the hashed version on the content backchain 76. If these do not match, then a mediator hold is placed onto the hold backchain 76. When a mediator hold is placed on the hold backchain 76 for a transaction, then all the parties (66 and others not shown) related to that transaction should consider that transaction as being aborted. The parties (66 and others not shown) may either move to a reduced mode of operation using only frontchains 72 or escalate the issue to a backchain initiator 62 governance mechanism.

Like all other holds, the mediator hold is built into a business process itself and all parties will react based on this business process. The backchain initiator 62, which presumably does not consider itself compromised, will itself read the hold backchain 76 and potentially react to a mediator hold.

The centralized backchain initiator 62 cannot influence the placement of mediator holds. Therefore, if transactions produced by means of the backchain initiator 62 are compromised (e.g., a transient trust violation), these transactions may be repudiated within the hold window 78.

Raising a mediator hold should be a very rare event. One, fairly radical, mechanism by which parties may deal with a mediator hold, is to stop using the backchain initiator 62 and move into a reduced mode of operation using only frontchains. Without limitation, a reduced-mode micro-community frontchain or traditional EDI may be used as a fall back in this situation. In practice, the problem will be escalated to some defined governance mechanism because the backchain initiator 62 is most likely an accountable entity of some sort.

Dealing with Dissimilar Views Resulting from the Split Process

According to one embodiment, the backchain initiator splits n-way multi-party transactions into n single-party transactions prior to hashing and/or encryption. The multi-party-transaction-split is performed using each party's corresponding read permission associated with the multi-party transaction. Generally, each party to a multi-party transaction has a different deep read permission associated with the multi-party transaction. Each party will therefore typically have different permissioned views associated with the underlying multi-party transaction.

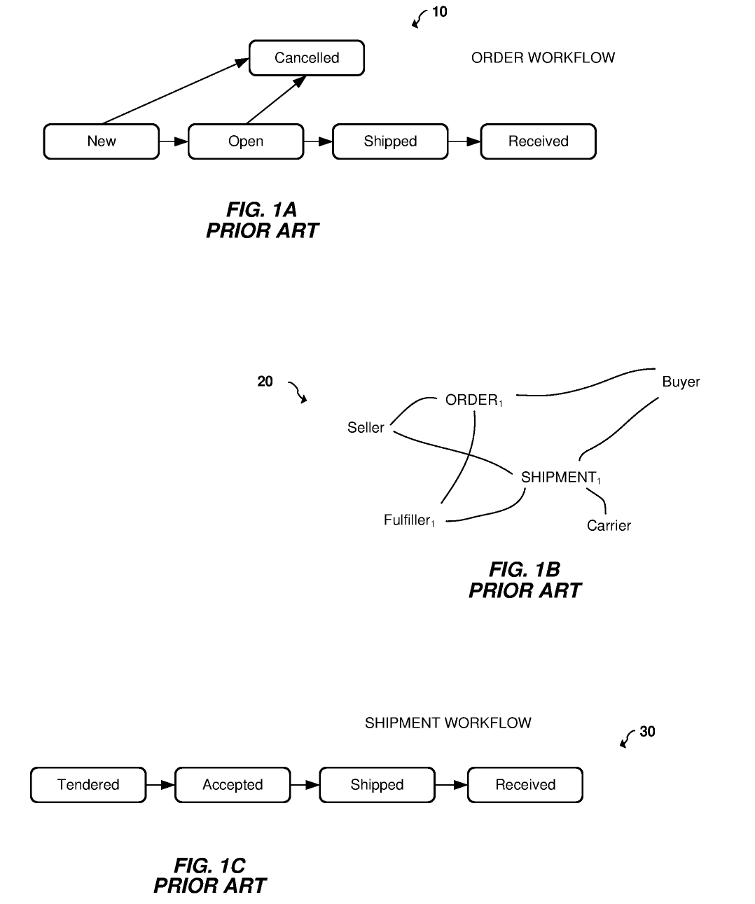

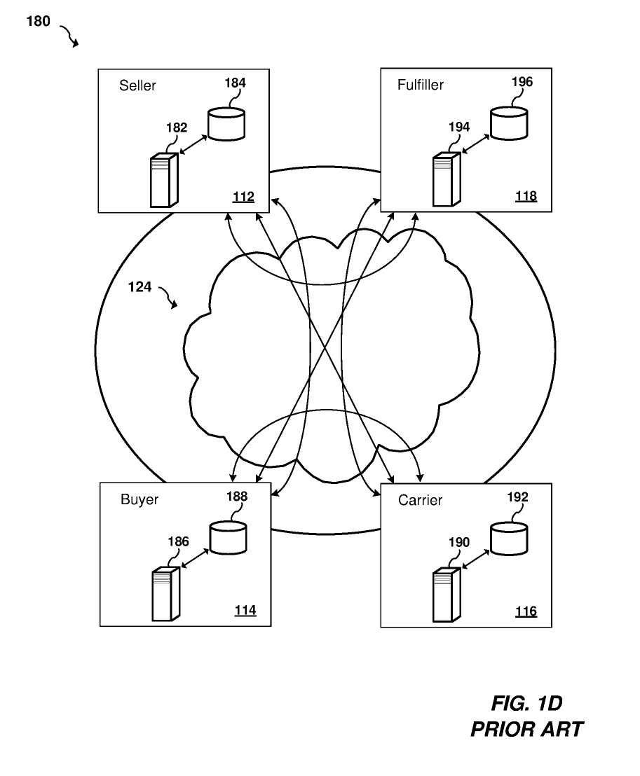

In the exemplary drop ship scenario discussed above and shown in FIGS. 1A-1C, fulfiller₁ should not have read permission to the price of the order and should therefore not be able to see the price of the order, but both the buyer and seller should have read permission and be able to see the price of the order. Let's now assume that the seller and fulfiller₁ have access to shared information on the same order that the buyer is not privy to. This scenario leads to a potential problem with non-repudiation of multi-party-transactions, which is essential to backchains. Each party can prove its own particular view of the underlying multi-party transaction, by presenting its view and showing that it hashes to the hash on the backchain. Such a scenario may present security problems. The only way in the prior art for a party to prove its view is for that party to present the entire view. However, the view for one or more of the parties to the multi-party-transaction may have information that party considers private. Another problem is proving that a shared multi-party transaction exists in a backchain transaction log will generally not be possible because each party's view will typically be different from other parties to the multi-party transaction.

According to one embodiment, the present invention overcomes the above deficiencies in the prior art by having the backchain initiator 62 determine all possible intersections of the single-party transaction views. These intersections are then hashed or encrypted as well. This determination is referred to herein as the multi-party-intersection algorithm. For example, let's assume there is a four-party transaction involving parties A, B, C and D, and the views of a particular transaction T are based on respective read-permissions V_{A}, V_{B}, V_{C} and V_{D}. This exemplary four-party transaction would have the two-way, three-way, and four-way intersections as described in the Table 3 below, where “*” is used to represent the intersection operator.

TABLE 3

| Type | Intersections |
|---|---|
| Two-way intersections | V_{A}*V_{B}, V_{A}*V_{C}, V_{A}*V_{D}, V_{B}*V_{C}, V_{B}*V_{D} and |
| | V_{C}*V_{D} |
| Three-way intersections | V_{A}*V_{B}*V_{C}, V_{A}*V_{B}*V_{D}, V_{A}*V_{C}*V_{D} and |
| | V_{B}*V_{C}*V_{D} |
| Four-way intersections | V_{A}*V_{B}*V_{C}*V_{D} |

Based on the above example, party A, B, C and D would each receive its view of the multi-party transaction along with all of the intersections related to transaction T. Note that it is possible that one or more intersections are empty. For example, party A, will be sent the following views as described in Table 4 below.

TABLE 4

| | |
|---|---|
| Party A views | V_{A}, V_{A}*V_{B}, V_{A}*V_{C}, V_{A}*V_{D}, V_{A}*V_{B}*V_{C}, V_{A}*V_{B}*V_{D}, |
| | V_{A}*V_{C}*V_{D} and V_{A}*V_{B}*V_{C}*V_{D} |

A cryptographic hash or encryption of all the intersections is then placed on the content backchain 74. In the above four-party example, there will be eleven hashes (or encrypted values) placed on the content backchain 74. If the existence of a shared transaction needs to be proved between parties (e.g., between party A and party B), the corresponding intersection between the relevant parties can be used to prove such existence. For example, if party A needs to prove the existence of a shared portion of a multi-party transaction with party B, then the A*B intersection may be used for non-repudiation purposes. Similarly, if party A needs to prove the existence of a shared portion of a multi-party transaction with party B and party C, then the A*B*C intersection may be used to prove such existence. Thereby, all possible subsets can be proven as necessary without the inherent deficiencies described above.

Generally, in an n-way multi-party transaction there will be nC₂+nC₃+nC₄+ . . . nCₙ intersection combinations, where C represents the combination operator. According to one embodiment, the content backchain 74 may be configured to only support pairwise non-reputability in which case only nC₂ intersections will be computed.

The intersections described above may be determined by various means. For instance, without limitation, general purpose algorithms like the longest common subsequence may be utilized in determining the intersections. A relational intersection may be utilized if the multi-party transaction is in relational form. The backchain initiator 62 may also be configured to create specialized intersection algorithms based on the format of the multi-party changeset. The nature of the particular intersection algorithm should have no impact on how overall multi-party-intersection algorithm operates.

### Encrypted Vs Cryptographically-Hashed Content Backchains

According to one embodiment, the content backchain 74, which contains transaction logs split by trading partner 66 (deep, matrixed) read permissions, do not store the entire split transaction in an unsecured or clear form. Instead, the split transaction content is stored in either an encrypted or hashed form.

The term “deep, matrixed permissions” is used herein to distinguish from the all-members-can-see-everything permissions characteristic of the community blockchains as described above.

According to one embodiment, the structure of a log message contained within the content backchain 74 includes (i) unencrypted metadata, and (ii) encrypted or cryptographically-hashed full content. Under an encryption approach, the full content is encrypted. The advantage of using an encryption approach is that a trading partner (66 and/or 66a-66d) can use their decryption key to recreate the entire subset of the supply chain state that they have deep read access to. However, the downside of this approach is that the entire shared supply chain state is replicated to all members (this is a basic property of blockchains) essentially providing an eternity in which other trading partners' encryption may be cracked. For this reason, cryptographically hashed content approach is preferred. A cryptographic hash can be thought of as essentially a digital fingerprint for a piece of content. Every distinct piece of content will have a unique cryptographic hash or fingerprint. It is a very easy to go from the content to the cryptographic hash, but impossible to go in the opposite direction. Therefore, a trading partners (66 and/or 66a-66d) will never be able to even attempt to decrypt another trading partner's (66 and/or 66a-66d) content. Additionally, using the content, it can be easily proven that the transaction content occurred by presenting it and determining that the cryptographic hash of the presented content matches the cryptographic hash on the content backchain 74.

To retrieve the transaction content that was cryptographically hashed and placed onto the content backchain 74, the backchain initiator 62 passes the sliced, encrypted transaction content and transmits it to the trading partner (66 and/or 66a-66d) using traditional non-blockchain means.

According to one embodiment, the present invention continuously monitors the content backchain 74 for any transactions relevant to a particular partner (66 and/or 66a-66d). If a transaction that is relevant to a particular partner is found, the content (which should have directly received from backchain initiator 62) is verified with the hash on the backchain. If the hashes do not match, then an invalid-hash mediator hold is raised on the hold backchain 76. If the original content is not received, then a no-content-received mediator hold is raised on the content backchain 74. The former should be a rare situation. The latter can happen more frequently, if for example there is a connectivity issue between the backchain initiator 62 and the trading partner (66 and/or 66a-66d).

With any mediator hold, the most drastic resolution is for the users or parties to move to a reduced mode of operation utilizing only frontchains 72. In practice, especially in a community setting, these will be escalated to community governance mechanisms.

Referring to FIG. 2E, a block diagram illustrating the internal structure of backchain initiator 62 in accordance with an embodiment of the present invention, is shown. FIG. 2E shows the Backchain Initiator in more detail. A write, also known as a command, is initiated against one or more business transactions against the backchain initiator 62. The backchain initiator 62 determines whether the trading partner has permissions to execute the command. If yes, then a transaction is initiated. The deep read and write permissions of the trading partner 66 relative to the business transaction is evaluated. If the trading partner 66 has the appropriate permissions, a subnet is retrieved from the single-version-of-the-truth mediated state store 86. The subnet is then passed to the business logic module which produces one or more write statements against the business transactions. These write statements are the executed and the transaction committed.

The mediated state store 86 automatically produces transaction event messages and places them in the data store log 88. A log enhancer 87 reads the transaction event messages from the data store log 88 and enhances it with the business transaction state, read permissions and command; as an enhanced event message. The resulting enhanced event message is then written to an enhanced event log 89. These enhanced event messages are read by a splitter/intersector 90 which splits the events by trading partner (66 and others not shown) permissions and creates intersections of all possible combinations of split events. The split events and intersected split events are grouped and placed onto trading partner specific logs (92a, 92b, 92c). These split and split-intersected events are then sent to the respective trading partner 66. For example, log 92a may correspond to trading partner 66 and is sent via a callback 93. The split and split-intersected events are then either cryptographically hashed or encrypted (94a, 94b, 94c) and passed to the content backchain broker 96 which places them onto the content backchain 74. In the case of encryption, the public key of the trading partner 66 is used for encryption. For example, in 94b, the public key corresponding to trading partner 66 would be used to encrypt the events so that only trading partner 66 could decrypt them. Block 84 represents an internal command, which is triggered via an internal event, and is otherwise very similar to the external command workflow described.

### FrontChains and BackChains

Frontchains are utilized for those supply chain applications where it is acceptable for everyone (or every member) to have access to the entire supply chain shared data state. An example of a frontchain 72 would be a frontchain for the chain of custody of high value items in a supply chain. Almost by definition, the everyone-can-read-everything problem is a not an issue for a chain-of-custody type application. Indeed, it is a requirement. This makes it ideal for a FrontChain application. For example, without limitation, diamonds might be considered a high value item in a supply chain.

However, the entire supply chain does not run on a frontchain 72. Instead, only specific supply chain applications are typically configured to run on the frontchain 72. Frontchains 72 may also be used for reduced-mode operations. For example, if trust in the backchain initiator 62 is lost, a pairwise micro-community frontchain 72 may be the fall back approach.

For supply chain applications where this is not desirable (which is most), the backchain system is used. This typically comprises three logical entities: (1) a backchain initiator 62; (2) a content backchain 74; and (3) a hold backchain 76. Optionally, the content backchain 74 and the hold backchain 76 may be combined into a single blockchain 64 as shown in FIG. 2C.

Referring to FIG. 2F, a block diagram illustrating an exemplary ecosystem showing the backchain system in accordance with an embodiment of the present invention, is shown.

As discussed above, the present invention utilizes blockchains to revolutionize supply chains. According to one embodiment of the present invention, a non-blockchain mediator, the backchain initiator 62, provides single-version-of-the-truth mediated shared state. According to another embodiment of the present invention, a content backchain 74 is utilized to reduce the trust required by participants from a perpetual trust to a transient trust. This embodiment also further protects against violations of transient trust via the hold backchain.

### Processing Flows

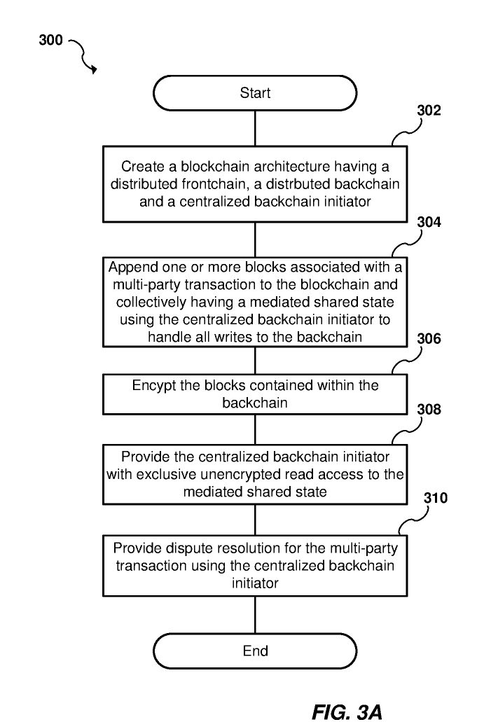

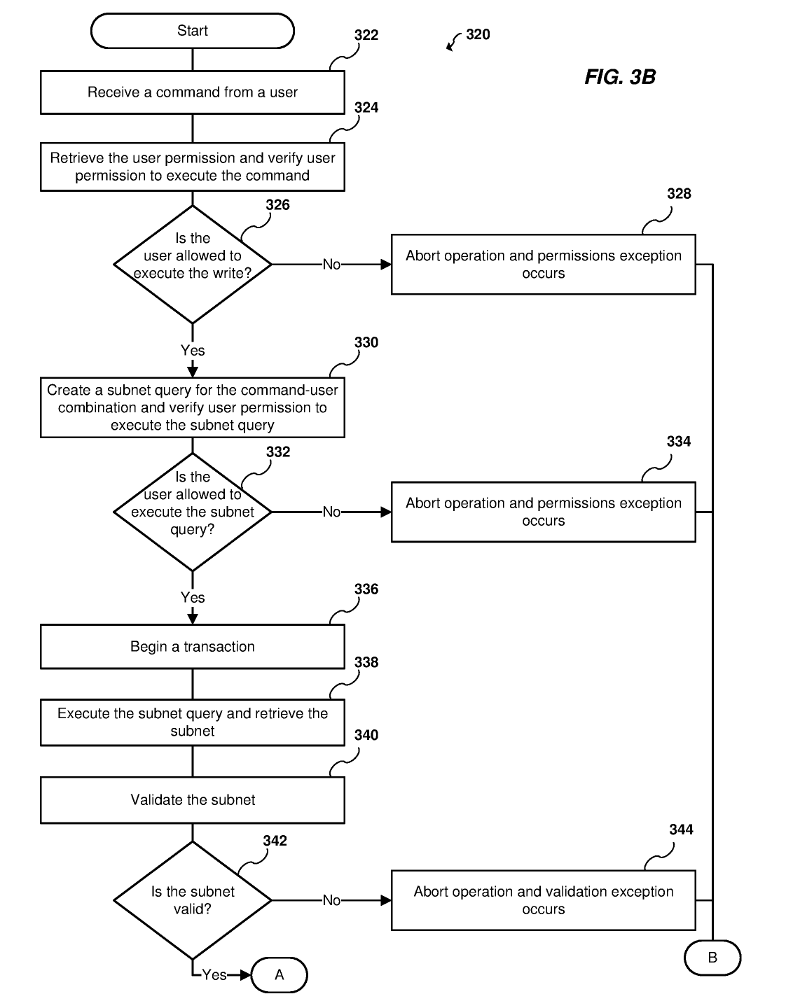

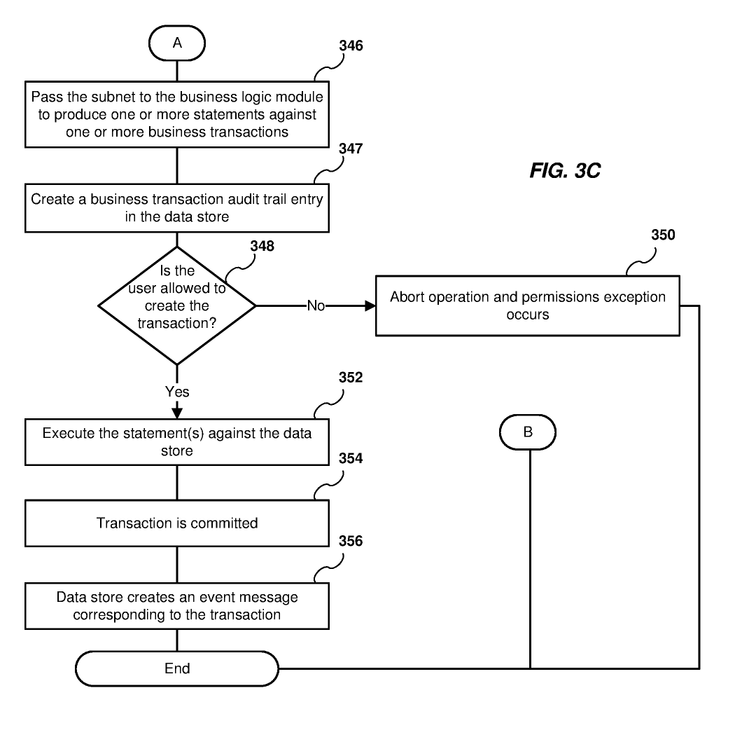

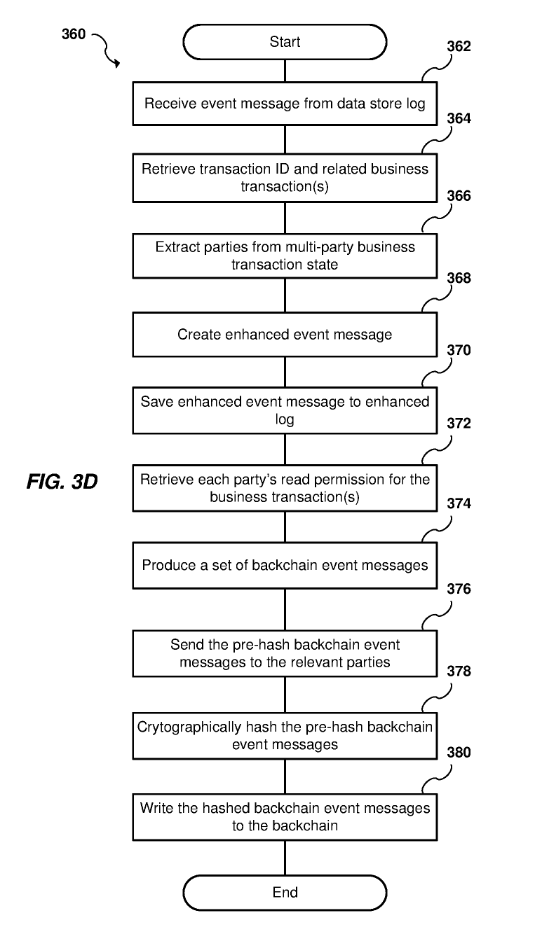

Referring to FIGS. 3A-3D, flow chart (300, 320 and 360) illustrating a method for implementing a blockchain in accordance with an embodiment of the present invention, is shown. At block 302, a blockchain architecture is created. The blockchain architecture includes a distributed frontchain, a distributed backchain and a physically distributed or centralized backchain initiator with centralized ownership. One or more blocks associated with a multi-party transaction to the blockchain are appended using the centralized backchain initiator to handle all writes to the backchain, at block 304. The one or more blocks associated with a multi-party transaction collectively have a mediated shared state. At block 306, the private fields within the transactions contained within the backchain are encrypted or cryptographically hashed. The centralized backchain initiator is provided exclusive unencrypted read access to the multi-party mediated shared state, at block 308. At block 310, dispute resolution for the multi-party transaction is provided by means of the centralized backchain initiator.

At block 322, a command is received from a user. The user permission is retrieved and the user permission to execute the command is verified, at block 324. At blocks 326 and 328, if the user is not allowed to execute the write, then it is aborted and a permissions exception occurs. At block 330, a subnet query for the command-user combination is created and the user permission to execute the subnet query is verified. At blocks 332 and 334, if the user is not allowed to execute the subnet query is verified, then it is aborted and a permissions exception occurs. The transaction begins, at block 336. At block 338, the subnet query is executed and the subnet is retrieved. The subnet is validated, at block 340. At blocks 342 and 344, if the validation fails, then the transaction is aborted and a validation exception occurs. At block 346, the subnet is passed to the business logic module to produce one or more statements against one or more business transactions. A business transaction audit trail entry is created in the data store, at block 347. At blocks 348 and 350, if the user is not allowed to create, then it is aborted and a permissions exception occurs. At block 352, the statement(s) are executed against the data store. The transaction is committed, at block 354. At block 356, the data store creates an event message corresponding to the transaction.

At block 362, the event message is retrieved from the data store log. The transaction ID and related business transaction(s) are retrieved, at block 364. At block 366, the parties are extracted from the multi-party business transaction state. An enhanced event message is created, at block 368. The enhanced event message includes a transaction ID, a timestamp, a list of parties, the state of the business transaction(s), and a comment. At block 370, the enhanced event message is saved to the enhanced log. Each party's read permission for the business transaction(s) is retrieved, at block 372. At block 374, a set of backchain event messages is produced. The set of backchain event messages include a command message, a split message for each party and an intersected message for each party. The command message includes a transaction ID, a timestamp, the list of parties, and a command that will be hashed. Each split message includes a transaction ID, a timestamp, a party, and a single party business transaction state that will be hashed. Each intersected message includes a transaction ID, a timestamp, the parties in the intersection, and the intersected business transaction state that will be hashed. The pre-hash backchain event messages are sent to the relevant parties, at block 376. The command event message is sent to all parties. The split event message is sent to the party in the split event message. The intersected event message is sent to all the parties in the intersected event message. At block 378, the pre-hash backchain event messages are cryptographically hashed. Alternatively, the pre-hash backchain event messages are encrypted instead of cryptographic hashed. The private fields are encrypted using the party's public key and then the resulting message is placed on the backchain. The backchain event messages are written to the backchain, at block 380.

The present invention may utilize or more computer applications. As used herein, a “computer application” is a computer executable software application of any type that executes processing instructions on a computer or embedded in a processor, and an “application” or “application project” are the files, objects, structures, database resources and other resources used in integrating a computer application into a software platform.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

This invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, portions of the invention may be embodied as a method, device, or computer program product. Accordingly, portions of the present invention may take the form of an entirely hardware embodiment or an embodiment combining software and hardware aspects all generally referred to as a “circuit” or “module.”

The present invention includes a computer program product which may be hosted on a computer-usable storage medium having computer-usable program code embodied in the medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Computer program code for carrying out operations of the present invention may be written in any programming language including without limitation, object oriented programming languages such as Java®, Smalltalk, C# or C++, conventional procedural programming languages such as the “C” programming language, visually oriented programming environments such as VisualBasic, and the like.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A system for implementing an improved blockchain for use in a value chain network, the system comprising:
a plurality of remote computers in communication with a respective plurality of value chain parties;
a service provider computer provided by a service provider over a network, wherein the service provider and the plurality of remote computers are collectively configured to implement a blockchain having one or more shared multi-party transactions represented by one or more blocks in the blockchain, and wherein each of the one or more shared multi-party transactions have a mediated shared state for two or more of the plurality of value chain parties;
a network interface in communication with the service provider computer and the plurality of remote computers over the network;
a backchain initiator residing on the service computer and in communication with the backchain initiator, wherein the backchain initiator is configured to receive all writes, and wherein the backchain initiator is provided exclusive unencrypted read access to the mediated shared state and maintains a single version of the truth for each of the mediated shared states; and
a content backchain produced by the backchain initiator, wherein the content backchain is configured to contain the one or more shared multi-party transactions; and
a hold backchain in communication with the plurality of value chain parties, wherein the hold backchain is configured to receive specialized writes from the plurality of value chain parties.

2. The system of claim 1, wherein the service provider computer is a cloud computer.

3. The system of claim 2, further comprising one or more frontchains in communication with the plurality of value chain parties, wherein the one or more frontchains are configured to receive all writes from the plurality of value chain parties, and wherein the backchain initiator does not receive any writes.

4. The system of claim 3, wherein the one or more frontchains are configured to receive all writes when everyone-can-see-everything is acceptable for the one or more shared multi-party transactions.

5. The system of claim 3, wherein the one or more frontchains are configured to receive all writes when there is a loss of trust in the backchain initiator.

6. The system of claim 2, wherein data within the one or more blocks is at least one selected from the group consisting of encrypted data and cryptographically hashed data.

7. The system of claim 6, wherein the backchain initiator splits the one or more shared multi-party transactions into single-party transactions for each of the plurality of value chain parties associated with each respective shared multi-party transaction prior to encrypting or cryptographically hashing the data.

8. The system of claim 7, wherein the backchain initiator:
determines intersection views for each of the plurality of value chain parties associated and each shared single-party transaction; and
encrypts or cryptographically hashes each intersection view.

9. The system of claim 8, wherein one or more of the encrypted or cryptographically hashed intersections views are used for non-repudiation.

10. The system of claim 2, wherein the single version of the truth for each of the mediated shared states is a historical single version of truth over time.

11. The system of claim 2, wherein only a transient trust is placed in the backchain initiator.

12. The system of claim 2, wherein a plurality of subnets each represent different portions of the mediated shared state.

13. The system of claim 12, wherein the backchain initiator executes an intelligent agent to retrieve at least one of the different portions of the mediated shared from one or more of the plurality of subnets.

14. The system of claim 2, wherein the specialized writes relate to a mediator hold in which there has been a loss of trust or there is an issue with the backchain initiator to ensure that the backchain initiator cannot tamper with the mediator hold.

15. The system of claim 14, wherein the mediator hold is configured to allow one or more of the plurality of value chain parties be repudiate one or more of the shared multi-party transactions placed onto the content backchain within a hold window.

16. A system for implementing an improved blockchain for use in a value chain network, the system comprising:
a plurality of remote computers in communication with a respective plurality of value chain parties;
a service provider computer provided by a service provider over a network, wherein the service provider and the plurality of remote computers are collectively configured to implement a blockchain having one or more shared multi-party transactions represented by one or more blocks in the blockchain, and wherein each of the one or more shared multi-party transactions have a mediated shared state for two or more of the plurality of value chain parties;
a network interface in communication with the service provider computer and the plurality of remote computers over the network;
one or more frontchains in communication with the plurality of value chain parties, wherein the one or more frontchains are configured to receive all writes from the plurality of value chain parties when everyone-can-see-everything is acceptable for the one or more shared multi-party transactions;
a backchain initiator residing on the service computer and in communication with the backchain initiator, wherein the backchain initiator is configured to receive all writes other than those writes which go directly to the one or more frontchains, and wherein the backchain initiator is provided exclusive unencrypted read access to the mediated shared state and maintains a transient single version of the truth for each of the mediated shared states; and
a content backchain produced by the backchain initiator, wherein the content backchain is configured to contain the one or more shared multi-party transactions.

17. The system of claim 16, wherein the one or more frontchains are further configured to receive all writes when there is a loss of trust in the backchain initiator.
